(19) United States
(12) Patent Application Publication
(10) Pub. No.: US 2026/0318568 A1
(43) Pub. Date: Oct. 15, 2026

(54) COLD SERVICEABLE CRYOGENIC SYSTEM

(71) Applicant: PHOTONIC INC., Coquitlam (CA)

(72) Inventor: John Leonard DUNN, Burnaby (CA)

(21) Appl. No.: 19/486,286

(22) PCT Filed: Apr. 3, 2024
(86) PCT No.: PCT/CA2024/050429

§ 371 Date: Nov. 20, 2025

Related U.S. Application Data
(60) Provisional application No. 63/506,510, filed on Jun. 6, 2023.

(51) Int. Cl. F25B 9/12

(52) U.S. Cl. CPC F25B 9/12

(57) ABSTRACT

The invention relates to a closed cycle cryogenic system (100) comprising a first refrigeration system (1) with a cold head (2) and a compressor (4) coupled to cold head (2); a vacuum shroud (5) at least partly receiving cold head (2); a radiation shield (6) enclosed by vacuum shroud (5); a second refrigeration system (8) at least partly enclosed by radiation shield (6) and thermally coupled to first refrigeration system (1) for providing a low temperature environment (230), wherein cold head (2) is releasable mounted in a receiving space (7) defined within radiation shield (6) and vacuum shroud (5), and the cryogenic system (100) further has a protective device (3) cooperating with cold head (2) and receiving space (7) to allow release of cold head (2) thereby preventing receiving space (7) from ingress of media differing from refrigerant. The invention further relates to a method for maintenance cryogenic system (100).

### CROSS REFERENCE TO RELATED APPLICATION

This application claims priority from U.S. application No. 63/506,510 filed 6 Jun. 2023 and entitled COLD SERVICEABLE CRYOGENIC SYSTEM which is hereby incorporated herein by reference for all purposes. For purposes of the United States of America, this application claims the benefit under 35 U.S.C. § 119 of U.S. application No. 63/506,510 filed 6 Jun. 2023 and entitled COLD SERVICEABLE CRYOGENIC SYSTEM which is hereby incorporated herein by reference for all purposes.

### FIELD OF THE INVENTION

The invention relates to a closed cycle cryogenic system for providing a low temperature environment, a quantum computer system having such a closed cycle cryogenic system and a method for maintaining such a closed cycle cryogenic system.

### BACKGROUND OF THE INVENTION

There is significant interest, both in scientific research and in certain commercial sectors to provide low temperature environments. In that regard, cryostats, also known in the art as cryogenic systems, have found application in basic research, high-tech, medical, pharmaceutical, and food industries.

In order to reduce the reliance of low temperature devices on a ready supply of helium, closed cycle cryogenic systems utilizing so called “cold heads” have been developed to remove heat directly from the cryostat, thereby removing the reliance on a ready supply of helium. The major components of closed cycle cryogenic system also known as closed cycle cryostat are a so-called cold head, a compressor, a vacuum shroud, and a radiation shield. The cold head is where the refrigeration cycle takes place. Cold heads in common use operate on one of two principles: Gifford-McMahon cold heads; and pulse-tube cold heads. Both types of cold heads are regenerative cryogenic coolers, and generally operate on compression-expansion cycle and have a hot section outside the cryogenic system and a cold section inside the cryogenic system. Further details of the operating principles of Gifford-McMahon cold heads and pulse-tube cold heads generally need not be elaborated for the purpose of this description.

In general, the cold head is connected to a compressor by two gas lines, including a supply line and a return line. One of the gas lines supplies high pressure helium gas to the cold head, while the other gas line returns low pressure helium gas from the cold head. The compressor provides the necessary helium gas flow rate at the high and low pressure for the cold head to convert into the desired refrigeration capacity. The vacuum shroud surrounds the cold end of the cold head in vacuum limiting the heat load on the cold head caused by conduction and convection. The radiation shield is actively cooled by the first stage of the cold head and insulates the second stage from the room temperature thermal radiation being emitted from the vacuum shroud. It is relevant to note however, that a single cold head can only achieve temperatures down to approximately 10 K. However, in both Gifford-McMahon and pulse-tube cold heads, the expansion systems can be ganged together in serial stages, such that the cooled gas of one stage may be used as a pre-cooler for a second stage, thus achieving a lower temperature. Two stage cold heads currently in use can achieve temperatures in the range of 2.5 K to 4.2 K.

A particular interest for providing low temperature environments is in quantum computing. In quantum computing applications, quantum information is stored in so-called qubits. Qubits are extremely delicate and require cryogenic temperatures for stability. For the purpose of providing low temperature environments for quantum computing, temperatures less than 2.5 K may be required. Thus, cryogenic systems of the aforementioned type comprise a second refrigeration system being thermally connected with the cold head for providing a low temperature environment with temperatures less than 4 K, in particular less than 2.5 K.

Accordingly, in particular in quantum computing it is advantageous to minimize the downtime of the cooling environment in which the qubit is housed by providing a cold-serviceable cryogenic system.

Cold heads are a serviceable component of the cryogenic system. In general, cold heads require service after a defined lifetime that can vary between 10,000 hours and 40,000 hours depending on design. Once it has been determined that a cold head requires servicing, the closed cycle cryogenic system must be warmed to room temperature to allow a safe disassembly of the system to remove the cold head and afterwards a safe assembly of the system including the new or serviced cold head. Warming the closed cycle cryogenic system is in particular necessary in order to recover the chemical and physical conditions within the closed cycle cryogenic systems, e.g. the purity and pressure of the atmosphere. However, warming the closed cycle cryogenic system to room temperature results in unwanted downtime. This problem is amplified in systems comprising a plurality of cold heads, in particular if only a subset of the cold heads is to be serviced.

### SUMMARY OF THE INVENTION

It is an object of the present invention to propose a concept for a closed cycle cryogenic system that enables servicing the cold head without warming the whole closed cycle cryogenic system to ambient temperature, in particular without the need to warm a second refrigeration system of the cryogenic system.

In a first aspect of the invention, a closed cycle cryogenic system is presented. The closed cycle cryogenic system comprises:
a first refrigeration system having at least one cold head and a compressor coupled to the cold head for carrying a compressed refrigerant to the cold head and returning low pressure refrigerant originating from the cold head,
a vacuum shroud at least partly enclosing the cold head and being configured to reduce convective heat transfer to the cold head,
a radiation shield enclosed by the vacuum shroud and being configured to insulate at least a part of the cold head from thermal radiation emitted from the vacuum shroud, wherein a receiving space at least partly extends through the radiation shield and the vacuum shroud, wherein the receiving space is configured to receive the cold head; and
a second refrigeration system at least partly enclosed by the radiation shield and thermally coupled to the first refrigeration system for providing the low temperature environment.
   The cold head is releasable mounted in the receiving space. The closed cycle cryogenic system further comprises at least one protective device associated to the receiving space, wherein the at least one protective device is configured to allow release of the cold head from the receiving space by protecting the receiving space from ingress of media differing from the refrigerant. By having the protective device that prevents the receiving space from ingress of media differing from the refrigerant, the physical and chemical conditions within the receiving space can be maintained or are at least less influenced by the release of the cold head. It shall be understood that unlike the receiving space which is at least in thermal connection with the second refrigeration system, the cold head is only in thermal connection with the second refrigeration system. Thus, an undesirable warming or contamination of the receiving space results in a contamination or warming of the second refrigeration system.

The cold head may include a first stage for executing a first cooling cycle for precooling the refrigerant, a second stage for executing a second cooling cycle for cooling the precooled refrigerant to a cryogenic temperature, and a thermal interface configured for coupling to the second refrigeration system, wherein the radiation shield is configured to insulate the second stage. The second refrigeration system may also have a substrate interface for providing the low temperature environment.

It shall be understood that the thermal connection between the second refrigeration system, in particular via the thermal interface, and the cold head is disconnected when releasing the cold head from the receiving space. The protective device provides two separate options for releasing the cold head from the receiving space. On the one hand, the cold head may be directly released from the receiving space and warmed separately from the cryogenic system after release.

An alternative option for releasing the cold head from the receiving space is to thermally isolate the cold head from the second refrigeration system and optionally to fluidically isolate the receiving space from the second refrigeration system. After thermal isolation, the cold head may be warmed to room temperature while remaining in the receiving space and released thereafter. Since the cold head is configured for thermal isolation from the second refrigeration system while being warmed within the receiving space, the physical and chemical conditions in the second refrigeration system are less influenced by the release of the cold head.

In particular, the protective device protects the receiving space from any chemical influences and, in particular, contamination of the atmosphere that may be caused by ingress of foreign media. Thus, after servicing, a new cold head may simply be inserted in the receiving space, wherein a seal from the cold head and/or the protective device to the receiving space is restored such that the atmosphere within the receiving space is protected from the environment, in particular from media differing from the refrigerant, during the whole servicing procedure. In case of a fluidic connection between the receiving space and the second refrigeration system, the second refrigeration system is further protected from the environment and, in particular, from media differing from the refrigerant.

The protective device may comprise a gate valve having a sealable passageway and an expandable vacuum space configured to allow movement of the cold head through the passageway relative to the receiving space. The expandable vacuum space allows moving a cold head relative to the thermal interface and the receiving space while maintaining the atmosphere in the receiving space. Thus, the cold head may be moved into a position, in which a thermal isolation of the cold head from the second refrigeration system is enabled. Further, the expandable vacuum space allows movement of the cold head through the passageway such that the passageway can be isolated while the atmosphere within the receiving space is still protected. It shall be understood that in the case of a sealable passageway, the receiving space is separated from the expandable vacuum space.

According to an embodiment, the closed cycle cryogenic system further comprises:
a first room temperature flange associated to the receiving space, and
a second room temperature flange associated to the cold head, wherein the protective device is arranged between the first room temperature flange and the second room temperature flange. The arrangement between the first room temperature flange and second room temperature flange allows an easy access for removing the cold head through the sealable passageway, while the receiving space is protected by the expandable vacuum space from the environment.

In some embodiments, the expandable vacuum space is attached to the receiving space and the cold head. Thus, a movement of the cold head relative to the receiving space is enabled while at least a part of the cold head is still enclosed by the expandable vacuum space. Thus, the receiving space is protected from the environment, avoiding ingress of any media differing from the refrigerant.

In some embodiments, the expandable vacuum space is defined by a bellows attached to the cold head which is configured to receive an exchange gas at least during and/or after release of the cold head from the receiving space. The bellows, for example an edge-welded bellows, may be coupled to the cold head. The bellows may have a maximum length in a fully extended state that is equal to the length of the cold head or even exceeds the length of the cold head. The bellows may be configured to remain in a fully compressed state as long as the cold head is received in the receiving space. For releasing the cold head from the receiving space, the bellows may extend to its fully extended state due to the movement of the cold head relative to the receiving space. The bellows may be filled with an exchange gas facilitating the removal of the cold head from the receiving space.

In some embodiments, the gate valve is associated to the receiving space and configured to preserve the integrity of the receiving space. When the gate valve is open, movement of the cold head being received in the receiving space through the passageway is allowed for releasing the cold head from the receiving space. After release of the cold head, namely after moving the cold head through the passageway, the gate valve is closed, thereby protecting the receiving space from any foreign media and contaminations. In addition, in embodiments in which the bellows is filled with an exchange gas, the gate valve is also configured to protect the receiving space from ingress and excess of the exchange gas when closing the passageway.

According to another embodiment, the protective device comprises a gas curtain configured to selectively fill the receiving space by maintaining a supply of an exchange gas corresponding to the refrigerant to prevent the receiving space from ingress of media differing from the refrigerant. An example of a gas curtain is described in U.S. Pat. No. 11,060,768B2. The gas curtain ensures a continual outward flow of pressurized gaseous medium from the receiving space during service of the cold head, wherein the gaseous medium corresponds to the refrigerant. The gas curtain allows filing the receiving space vacated by the cold head with helium.

In some embodiments, the closed cycle cryogenic system further comprises a pressure reservoir and a control valve configured to selectively connect the pressure reservoir with the expandable vacuum space or the gas curtain in a fluid conduction manner. Thus, providing continuous supply of exchange gas for the bellows or the gas curtain.

In some embodiments, the refrigerant in the first refrigeration system is a first refrigerant and the cryogenic temperature to which the first refrigerant is cooled is a first cryogenic temperature. The second refrigeration system may be in thermal connection with the cold head and configured for cooling a second refrigerant to a second cryogenic temperature being below the first cryogenic temperature. The second refrigeration system may be a helium-3-system, a dilution refrigerator, an ADR cryostat or any other suitable refrigeration system. By having a thermal connection of both refrigeration systems, the performance of the closed cycle cryogenic system is enabled. It should be understood that the first and second refrigerants may be identical or different in substance.

According to an embodiment, the closed cycle cryogenic system further comprises a first cooling station, in particular a 50K plate, and a second cooling station, in particular a 4K plate. The second stage of the cold head may be arranged at a first distance from the first cooling station and a second distance from the second cooling station, wherein the second cooling station is cooler than the first cooling station and the second distance is smaller than the first distance. The second distance may be 1/15 or less of the first distance. Such configuration facilitates better heat exchange between the second cooling stage of the cold head and the second cooling station.

In some embodiments, the refrigerant comprises helium and the cold head is configured to cool the refrigerant to the cryogenic temperature. In particular, the cold head may be configured to cool the first refrigerant to the first cryogenic temperature. The fact that helium remains a liquid at cryogenic temperatures allows the use of helium in a refrigeration system with only moderate pressures. Liquid helium is a suitable cryogenic fluid that may be used as a refrigerant e.g. by evaporation of the liquid.

In some embodiments, the first cooling station is configured to actively cool the radiation shield. The radiation shield is configured to insulate the second cooling station from the room temperature thermal radiation emitted from the vacuum shroud. The temperature of the first cooling station may be below room temperature. A temperature below room temperature allows cooling of the radiation shield in order to protect the second cooling station from the room temperature thermal radiation.

In some embodiments, the closed cycle cryogenic system further comprises at least one electrical heater coupled to the cold head and configured for heating the cold head in case the cold head is released. In general, the cold head will warm up on its own having turned off the compressor. However, by providing one or more electrical heaters coupled to the cold head, the cold head may be warmed faster.

According to an embodiment, the cold head is a first cold head and the closed cycle cryogenic system comprises a plurality of cold heads including the first cold head. Each cold head of the plurality of cold heads may include a respective first stage and a second stage. Each cold head may be coupled to a respective compressor via a supply line and return line. Each cold head of the plurality of cold heads may be in thermal connection with the second refrigeration system for cooling a quantum processor. Each cold head of the plurality of cold heads may be releasably mounted in a corresponding receiving space of a plurality of receiving spaces. The plurality of receiving spaces may have at least one protective device which is coupled to one, more or all of the plurality of receiving spaces and configured to allow release of one, more or all of the plurality of cold heads. Thus, each cold head may be serviced independent of other cold heads in the system. This enables maintaining a temperature environment with less warming of the cryogenic system while only a part of the plurality of cold heads is released for servicing. Obviously, also two or more of the plurality of cold heads may be serviced at the same time, while the protective device is configured to protect each receiving space in which the cold head is released from the ingress of media differing from the refrigerant.

In some embodiments, each one of the plurality of receiving spaces is coupled to an associated protective device. Thus, each receiving space can be protected from ingress of media differing from the refrigerant by having a respective protective device independent from the other receiving spaces.

In some embodiments, the second refrigeration system is a dilution refrigerator. In conventional dilution refrigerator (“CDR”) designs, mechanical pumps and compressors, and an external gas-handling system, are used to circulate 3He such that it is warmed from the lowest temperature in the fridge up above cryogenic temperatures and towards room temperature before it is returned to the low temperature.

In some embodiments, the second refrigeration system is a 3He/4He dilution refrigerator. 3He/4He dilution refrigerators are cryogenic devices that provides continuous cooling to temperatures as low as 2 mK, with no moving parts in the low-temperature region. The cooling power of the system is provided by the heat of mixing of the Helium-3 and Helium-4 isotopes. In the operation of a typical dilution refrigerator, the apparatus itself requires a background temperature of about 4K. Thus, the apparatus is typically immersed in an evaporating bath of liquid helium-4 (“4He”) to provide the 4K background.

In some embodiments, the first refrigeration system includes a first circulation loop. The second refrigeration system includes a second circulation loop, wherein the cold head is configured for cooling the second refrigerant for the second circulation loop to thereby liquefy the second refrigerant. In closed cycle cryogenic systems, a second circulation loop may be used to provide operating temperatures below the first cryogenic temperature that is attainable by the first circulation loop having the cold head. The second circulation loop is in thermal connection with the first circulation loop but fluidically isolated from the first circulation loop. In the second circulation loop, the second refrigerant, e.g. liquefied helium, is cooled to a second cryogenic temperature below the first cryogenic temperature. Said second circulation loop may be used for example, to provide a low temperature environment for a quantum processor.

In some embodiments, the second refrigeration system, in particular the second circulation loop is configured to cool below 2K. Thus, a sufficiently low temperature, e.g. for cooling a quantum processor is provided.

In some embodiments, the second circulation loop comprises a vacuum pump. The second circulation loop may further have an expansion valve. The term expansion valve relates to any number of expansion valves that can effectively be used to expand a fluid for the purposes of cooling the fluid, including, but not limited to, J-T valves, needle valves, capillary tube arrays, and porous ceramic constructions, for example. J-T valves are also called “isenthalpic expansion valves”).

The vacuum pump is configured for pumping helium vapor within the second circulation loop through a pumping line. In some embodiments, the pumped second refrigerant is returned to the second circulation loop for re-condensing, completing the closed cycle of the cryogenic system. Thus, the refrigerant is recirculated by the vacuum pump.

In some embodiments, the second refrigeration system, in particular the second circulation loop, is configured for evaporative cooling and includes a 1-K pot.

In some embodiments, the radiation shield is a first radiation shield and the second circulation loop comprises a second radiation shield configured to insulate the second circulation loop from thermal radiation emitted from the first radiation shield. By having a second radiation shield configured to insulate the second circulation loop from the thermal radiation emitted from the first radiation shield, the efficiency of the second circulation loop is improved.

In some embodiments, the closed cycle cryogenic system includes a tank for receiving excess gas from at least one of the receiving space. The excess gas may be pumped by a vacuum pump or the vacuum pump of the second refrigeration system. The closed cycle cryogenic system may further have a tank control valve such as a pneumatic or solenoid valve, and an evacuation valve for selectively connecting the cold head to the tank for evacuating the excess gas. Evacuating the excess gas allows a faster heating of the cold head and thus reduced time for maintenance.

It shall be understood that the excess gas may be identical or different in substance from the refrigerant, in particular from the first and second refrigerant. Further, the excess gas in the receiving space may be fluidic when the cold head is received in the receiving space.

In a second aspect of the invention, a quantum computer system is presented. The quantum computer system comprising a quantum processor operating at cryogenic temperatures and a closed cycle cryogenic system according to the first aspect of the invention, configured to provide a low temperature environment for the quantum processor. By having a closed cycle cryogenic system according to the first aspect of the invention, the quantum computer system has the same benefits and preferred embodiments as described with regard to the first aspect of the invention. Further detail and embodiments of exemplary quantum processors that may be used in conjunction with the present systems, methods, and apparatus are known in the art and for example described in US Patent Publication No. 2006-0225165 or US Patent Publication No. 2008-0176750.

In a third aspect of the invention, a method for maintenance of a closed cycle cryogenic system, such as a closed cycle cryogenic system according to the first aspect of the invention is presented. Such a system may comprise a cold head for providing a refrigerant at a first cryogenic temperature, a compressor coupled to the cold head, and a second refrigeration system in thermal connection with the cold head for cooling a quantum processor and a thermal interface at least partly enclosed by the radiation shield and being configured for thermally coupling the first refrigeration system to the second refrigeration system. The method for maintenance of a closed cycle cryogenic system comprises the steps:
evacuating excess gas from the receiving space, for example by selectively opening a tank control valve and pumping the excess gas into at least one tank, the receiving space enclosed by a radiation shield and a vacuum shroud
warming the cold head,
releasing the cold head from a receiving space, and
during and after release of the cold head, preventing the receiving space from ingress of media differing from the refrigerant using a protective device associated to the receiving space. By preventing the receiving space from ingress of media differing from the refrigerant during and after release of the cold head, the method has the same benefits and preferred embodiments as described with regard to the first aspect of the invention.

In some embodiments, the step of warming the cold head is executed by one or both of the following:
turning off the compressor,
turning on an electric heater coupled to the cold head. In general, the cold head will warmup on its own having turned off the compressor, yet one or more electrical heaters coupled to the cold head allow to speed up the warming process of the cold head thereby reducing the downtimes of the closed cycle cryogenic system.

According to an embodiment, the method further comprises the step: thermally isolating the cold head from the second refrigeration system, for example a second circulation loop, wherein the step of warming the cold head is executed before releasing the cold head from a receiving space. Thermally isolating the cold head from the second refrigeration system allows to warm the cold head while still received in the receiving space without significantly influencing the second refrigeration system. Thus, by warming the cold head before release of the cold head, the handling of the cold head is simplified in order to ensure a safe release of the cold head.

According to an embodiment, the method further comprises the step: fluidically isolating the receiving space from the second refrigeration system, for example a second circulation loop, wherein the step of warming the cold head is executed after releasing the cold head from a receiving space. When fluidically isolating the receiving space from the second refrigeration system, releasing the cold head before warming the cold head ensures that the second refrigeration system is not heated together with the cold head and thus influenced by the release of the cold head.

In some embodiments, fluidically isolating the receiving space from the second refrigeration system of the system includes closing a needle valve and a shut-off valve. The needle valve allows a simple handling for isolating the cold head.

In some embodiments, the method further comprises the step of limiting the amount of pressure within the closed cycle cryogenic system, for example the second circulation loop, by opening a pressure relief valve. The pressure relief valve prevents pressure build up within the second circulation loop or the thermal interface and the closed cycle cryogenic system as a whole. The pressure may build up as a result of closing the needle valve in order to isolate the cold head from the second refrigeration system.

In some embodiments, releasing the cold head includes moving the cold head through a passageway of the protective device having a gate valve. In a further embodiment, preventing the receiving space from ingress of media differing from the refrigerant includes fluidically isolating the passageway by the gate valve. Thus, the time necessary for warming of the cold head can be reduced since the low temperature helium within the cold head and/or receiving space is evacuated.

According to an embodiment the protective device comprises an expandable vacuum space defined by a bellows attached to the cold head. The method may further comprise the steps:
opening a control valve to selectively connect a pressure reservoir with the protective device in a fluid conduction manner, and
filling the bellows with exchange gas during or after release of the cold head from the receiving space. Filling the bellows with exchange gas during release of the cold head may support the release of the cold head.

In some embodiments, the method comprises the steps:
breaking a vacuum seal on the cold head to the expandable vacuum space,
removing the cold head,
restoring vacuum seal on a new cold head to the expandable vacuum space,
evacuating the expandable vacuum space,
opening the gate valve and moving the new cold head through the passageway and into the receiving space,
closing the control valve to stop supply of exchange gas,
precooling the cold head by starting compressor, and
thermally connecting at least one of the cold head and receiving space to the second refrigeration system, and optionally fluidically connecting the receiving space to the to the second refrigeration system. Thus, the system can be operated in a secure manner after executing the mentioned steps including the step of restoring the vacuum seal on a new cold head to the expandable vacuum space.

In some embodiments, the protective device comprises a gas curtain and the method further comprises the steps:
opening a control valve to selectively connect a pressure reservoir with the protective device in a fluid conduction manner, and
filling the receiving space with an exchange gas corresponding to the refrigerant from the reservoir. By filling the receiving space with an exchange gas corresponding to the refrigerant from the reservoir the ingress of media differing from the refrigerant different than the refrigerant is avoided. Such a supply of an exchange gas may result in the formation of a gas curtain servicing as a protective device.

According to an embodiment, the method further comprises the steps:
breaking a vacuum seal on the cold head to the receiving space,
removing the cold head,
restoring vacuum seal on a new cold head the receiving space,
closing the control valve to stop supply of exchange gas,
precooling the cold head by starting compressor, and
thermally connecting the cold head to the second refrigeration system, and optionally fluidically connecting the receiving space to the to the second refrigeration system. Thus, the system can be operated in a secure manner after executing the mentioned steps including the step of restoring the vacuum seal on a new cold head.

It shall be understood that the closed cycle cryogenic system of claim 1, the quantum computer system of claim 24, and the method of claim 25, have similar and/or identical preferred embodiments, in particular, as defined in the dependent claims.

It shall be understood that an embodiment of the present disclosure can also be any combination of the dependent claims or above embodiments with the respective independent claim. These and other aspects of the invention will be apparent from and elucidated with reference to the embodiments described hereinafter.

### BRIEF DESCRIPTION OF THE DRAWINGS

In the following drawings:

FIG. 1 shows a closed cycle cryogenic system schematically according to a first embodiment,

FIG. 2 shows a closed cycle cryogenic system schematically according to a second embodiment with a cold head received in a receiving space,

FIG. 3 shows a closed cycle cryogenic system schematically according to the second embodiment with the cold head released from the receiving space,

FIG. 4 shows a closed cycle cryogenic system schematically according to a third embodiment with a cold head received in a receiving space,

FIG. 5 shows a closed cycle cryogenic system schematically according to the third embodiment with the cold head released from the receiving space,

FIG. 6 shows a diagram of a quantum computer system with the closed cycle cryogenic system schematically according to the first embodiment,

FIG. 7 shows a diagram of a quantum computer system with the closed cycle cryogenic system schematically according to the second embodiment,

FIG. 8 shows a flow chart illustrating a method for operating the closed cycle cryogenic system according to FIG. 1 to FIG. 3 according to the first embodiment,

FIG. 9 shows a flow chart illustrating a method for operating the closed cycle cryogenic system according to FIG. 1, FIG. 4, and FIG. 5 according to the second embodiment,

FIG. 10 shows a flow chart illustrating a method for operating the closed cycle cryogenic system according to FIG. 1 to FIG. 3, and

FIG. 11 shows a flow chart illustrating a method for operating the closed cycle cryogenic system according to FIG. 1 to FIG. 3.

### DETAILED DESCRIPTION

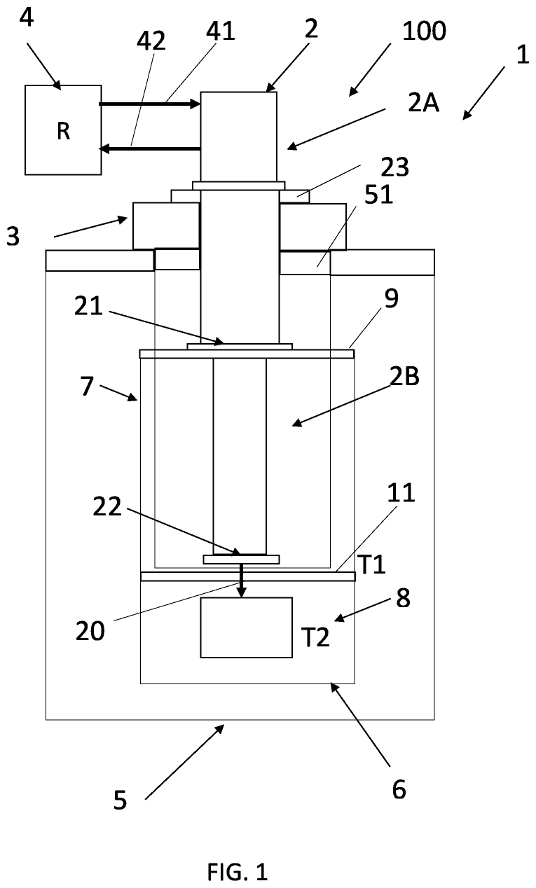

FIG. 1 to 5 show different embodiments of a closed cycle cryogenic system 100. Similar parts have identical reference numeral in the shown embodiments. The closed cycle cryogenic system 100 comprises a first refrigeration system 1 with a cold head 2 as schematically shown in FIG. 1 to 5. It shall be understood that, for example, either a Gifford-McMahon or pulse-tube type cold head can be equally employed in the closed cycle cryogenic system 100 according to the invention.

In FIG. 1, the closed cycle cryogenic system 100 has a first refrigeration system 1. The first refrigeration system 1 has the cold head 2, a compressor 4 coupled to the cold head 2 via a supply line 41 for carrying compressed refrigerant R to the cold head 2, and a return line 42 for returning low pressure refrigerant R originating from the cold head 2.

The closed cycle cryogenic system 100 further has a vacuum shroud 5 at least partly receiving the cold head 2 and a radiation shield 6 enclosed by the vacuum shroud 5.

The cold head 2 includes a first stage 21 for executing a first cooling cycle for precooling the refrigerant R and a second stage 22 for executing a second cooling cycle for cooling the precooled refrigerant to a cryogenic temperature T1. The vacuum shroud 5 is configured to reduce convective heat transfer to the first stage 21 and to the second stage 22. The radiation shield 6 may be actively cooled by the first stage 21 of the cold head 2 and configured to isolate the second stage 22 from thermal radiation emitted by the vacuum shroud 5.

The closed cycle cryogenic system 100 further has a receiving space 7, wherein the cold head 2 is releasably mounted in the receiving space 7. The receiving space 7 at least partly extends through the radiation shield 6 enclosed by the vacuum shroud 5. The closed cycle cryogenic system 100 and in particular the first refrigeration system 1 further comprises a protective device 3 cooperating with the cold head 2 and being associated to the receiving space 7 to allow release of the cold head 2 from the receiving space 7 while protecting the receiving space 7 from ingress of media differing from the refrigerant R.

The first refrigeration system 1 further has a thermal interface 20. The closed cycle cryogenic system 100 further includes a second refrigeration system 8 that is coupled to the first refrigeration system 1 via said thermal interface 20.

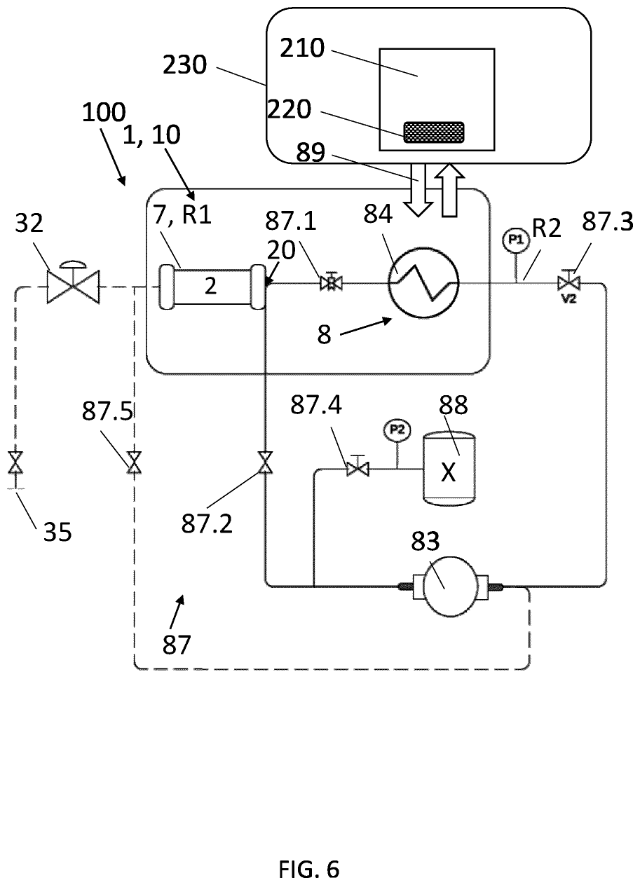

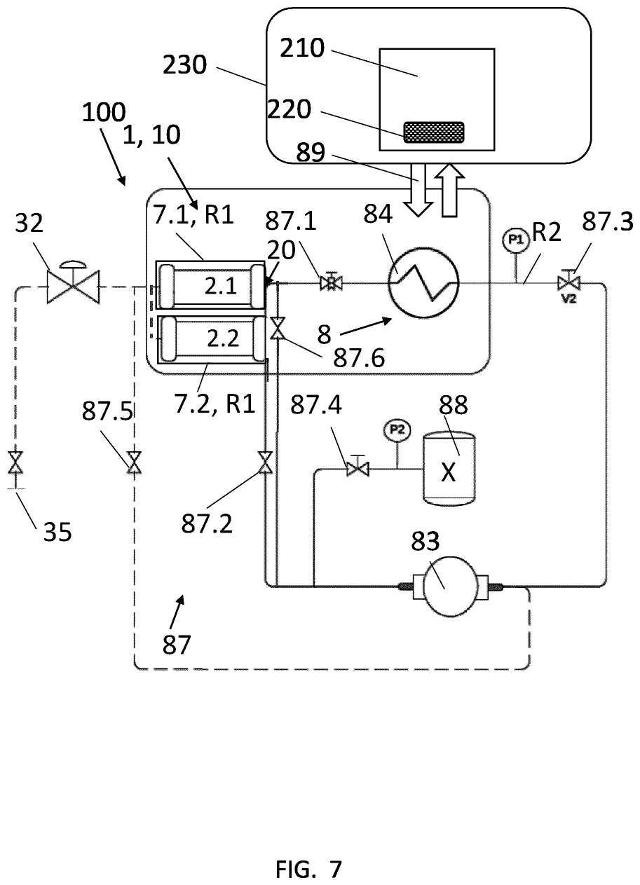

The second refrigeration system 8 is enclosed by the radiation shield 6 in the shown embodiment and has a substrate interface 89 (cf. FIGS. 6 and 7) for providing a low temperature environment to a substrate (not shown).

The closed cycle cryogenic system 100 further comprises a first cooling station 9 that is for example provided by a first cooling plate and a second cooling station 11 that may be provided by a second cooling plate. The first cooling station 9 is associated to the first stage 21 of the cold head 2 and the second cooling station 11 is associated to the second stage 22 of the cold head 2. In detail, the first stage 21 of the cold head 2 is in thermal connection with the first cooling station 9 and the second stage 22 of the cold head 2 is in thermal connection with the second cooling station 11.

The cold head 2 has a first part 2A maintained at room temperature and arranged outside the vacuum shroud 5. A second part 2B of the cold head 2 is kept below room temperature and arranged within the vacuum shroud 5. The receiving space 7 comprises a first room temperature flange 51 arranged adjacent to the first part 2A of the cold head 2. The first part 2A of the cold head 2 comprises a second room temperature flange 23. The second part 2B of the cold head 2, in particular the first stage 21 or the second stage 22 may comprise an optional electric heater 25.

The protective device 3 is arranged between the first room temperature flange 51 and the second room temperature flange 23.

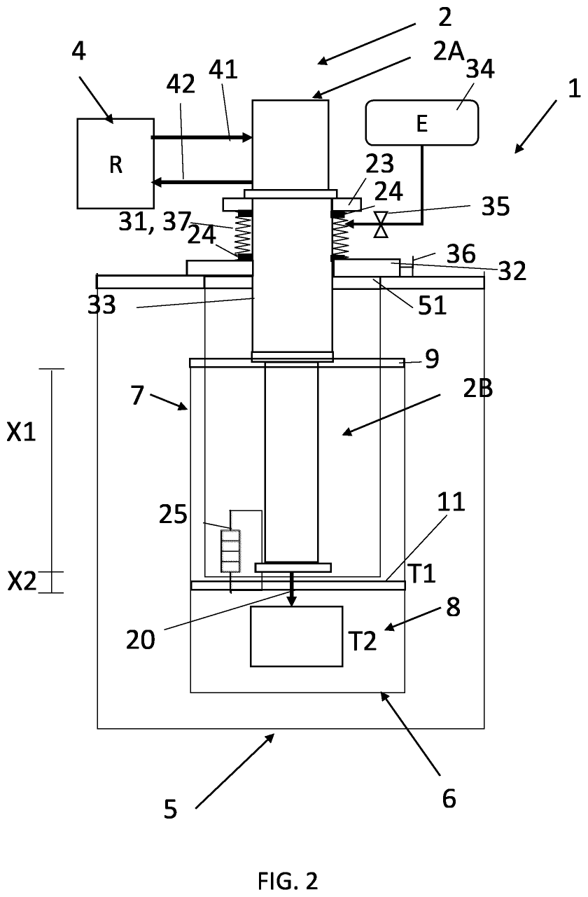

In the shown embodiment, the second stage 22 of the cold head 2 is arranged at a first distance X1 (labelled on FIG. 2 and applies analogously to FIG. 1) from the first cooling station 9 and at a second distance X2 (labelled on FIG. 2 and applies analogously to FIG. 1) from the second cooling station 11. The second cooling station 11 is cooler than the first cooling station 9 and the second distance X2 is smaller than the first distance X1. Thus, a good heat transfer between the second stage 22 of the cold head 2 and the second cooling station 11 is provided and heat transfer is reduced between the second stage 22 and the first cooling station 9. In particular, the configuration allows for better heat transfer between the second stage 22 of the cold head 2 and the second cooling station 11 in comparison to the heat transfer between the second stage 22 of cold head 2 and the first cooling station 9.

The first refrigeration system 1 is thermally coupled to the second refrigeration system 8 via the thermal interface 20.

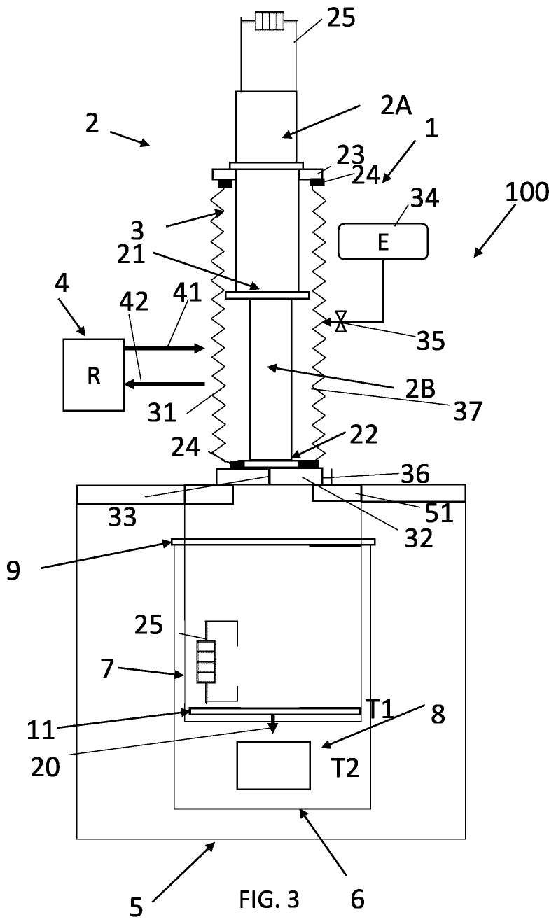

FIGS. 2 and 3 show the closed cycle cryogenic system 100 according to a second embodiment. The second embodiment differs from the first embodiment shown in FIG. 1 in the design of the protective device 3. Similar parts have identical reference signs in the figures. In order to avoid repetitions, reference is made to the above description of FIG. 1 and only differences between the first embodiment and the second embodiment are described in detail.

FIG. 2 shows the closed cycle cryogenic system 100 with the cold head 2 being received in the receiving space 7. FIG. 3 shows the closed cycle cryogenic system 100 with the cold head 2 being released from the receiving space 7.

The protective device 3 comprises a gate valve 32 having a sealable passageway 33. The protective device 3 further has an expandable vacuum space 31 configured to allow movement of the cold head 2 relative to the receiving space 7 through the passageway 33 for releasing the cold head 2 from the receiving space 7.

The expendable vacuum space 31 is attached to the receiving space 7 and the cold head 2. In particular, the expandable vacuum space 31 is attached to the first room temperature flange 51 of the receiving space 51 and to the second room temperature flange 23 of the cold head 2 by vacuum seals 23 and 24.

In FIG. 2, a vacuum is provided within the expandable vacuum space 31 to ensure integrity of the atmosphere within the receiving space 7.

The expandable vacuum space 31 is defined by a bellows 37 that is associated to the cold head 2 and the receiving space 7. The bellows 37 is configured to receive an exchange gas E during and/or after release of the cold head 2 from the receiving space 7.

As shown in FIG. 2 and FIG. 3, the gate valve 32 is further associated to the receiving space 7, i.e. attached to the latter, and configured to preserve the integrity of a vacuum in the receiving space 7. The bellows 37 is coupled to the cold head 2 by the vacuum seal 23 ensuring the integrity of the bellows 37 and avoiding ingress of any foreign media differing from the refrigerant R.

The protective device 3 further has a pressure reservoir 34 and a control valve 35 configured to selectively connect the pressure reservoir 34 with the bellows 37 for providing the exchange gas E to fill the bellows 37. The bellows 37 may be coupled to the pressure reservoir 34 by means of any suitable ports. By filling the bellows 37, the release of the cold head 2 is supported as the bellows 37 expands over the whole length of the cold head 2 as shown in FIG. 3.

After moving the cold head 2 through the passageway 33, the gate valve 32 is operated to close the passageway 33 and isolate the receiving space 7. Alternatively, an actuation member 36 may be used for closing the passageway 33. By closing the gate valve 32, the receiving space 7, the vacuum shroud 5 and the radiation shield 6 are protected from ingress of foreign media differing from the refrigerant R and also from ingress of the exchange gas E that is fed into the bellows 37 via the control valve 35.

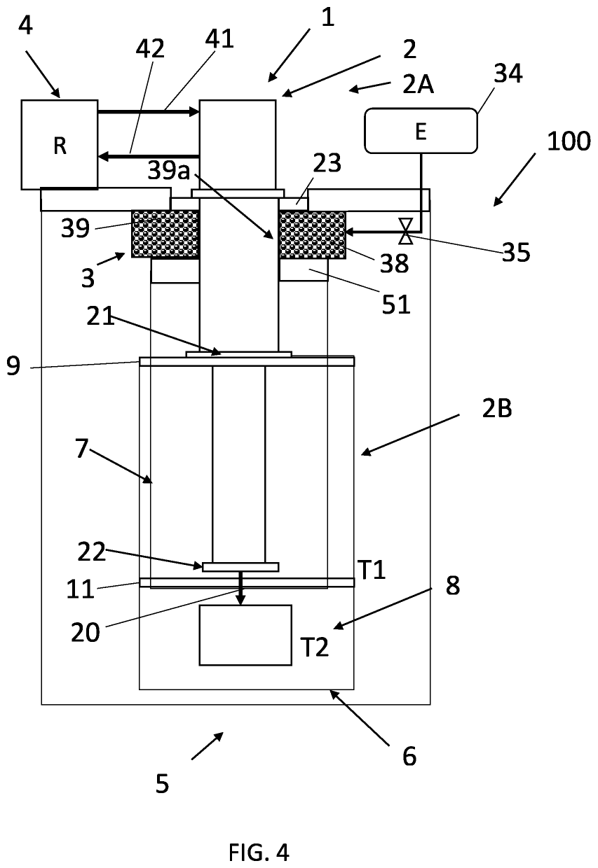

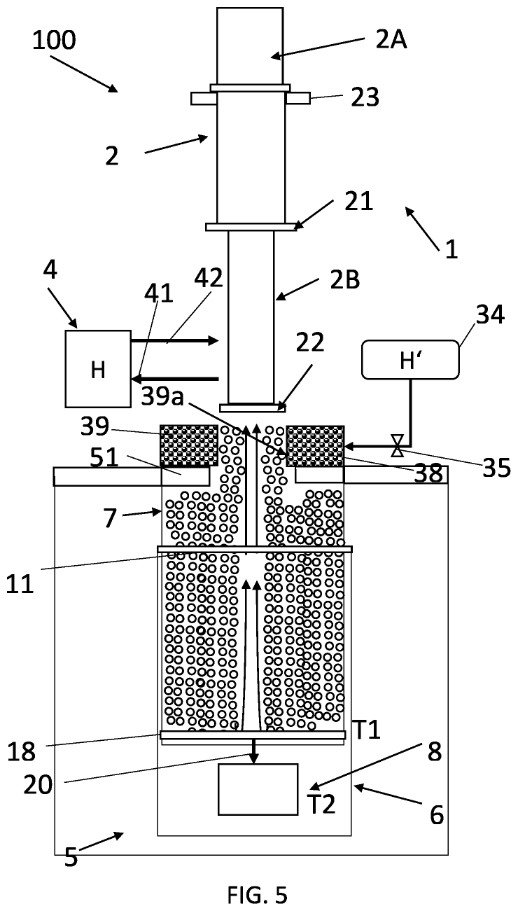

FIG. 4 and FIG. 5 show a third embodiment of the closed cycle cryogenic system 100 which differs from the first embodiment shown in FIG. 1 in the design of the protective device 3. Similar parts have identical reference signs in the figures. In order to avoid repetitions, reference is made to the above description of FIG. 1 and only differences between the first embodiment and the third embodiment are described in detail.

FIG. 4 shows the closed cycle cryogenic system 100 with the cold head 2 being received in the receiving space 7. FIG. 5 shows the closed cycle cryogenic system 100 with the cold head 2 being released from the receiving space 7.

The protective device 3 according to the third embodiment comprises a gas curtain 38 having an annular header 39 around the receiving space 7 attached to the vacuum shroud 5. In detail, the annular header 39 may be arranged between the first room temperature flange 51 and the second room temperature flange 23 (e.g., as shown in FIG. 4).

In the other embodiments, the gas curtain 38 with the annular header 39 may be arranged within the vacuum shroud 5 (e.g., as shown in FIG. 5).

The annular header 39 has a number of apertures 39a (such as slits) exiting into a flow path into the receiving space 7. The protective device further comprises a control valve 35 and a pressure reservoir 34 associated to the gas curtain 38 for providing exchange gas E to the gas curtain 38, such that gas flows through the number of apertures 39a into the receiving space 7. As in particular shown in FIG. 5, the supply of exchange gas E from the gas curtain 38 at least partly blocks the passageway of the receiving space 7 and at the same time results in an outward flow from the receiving space 7 of the previously introduced exchange gas E that both prevent ingress of any foreign media differing from the refrigerant R.

The supply of pressurized exchange gas E from the pressure reservoir 34 is continued when the cold head is removed, as indicated in FIG. 5. The supply is maintained until the cold head 2 is replaced and the vacuum of the receiving space is restored. The gas curtain 38 is configured to provide a continuous flow of exchange gas out of the open end of the receiving space 7, and so prevents e.g. air from entering the receiving space 7. When the cold head 2 is returned into the receiving space 7 and the vacuum seal 25 is restored, the supply of pressurized exchange gas E is stopped via the control valve 35.

FIG. 6 is a schematic diagram of a quantum computer system 200 with a retrofitted closed cycle cryogenic system 100 for providing a low temperature environment 230 for a quantum processor 210. The cryogenic system 100 comprises a first refrigeration system 1 with a cold head 2, wherein the cold head 2 may be designed according to any of the embodiments shown in FIG. 1 to FIG. 5. However, in the shown embodiment the cold head 2 is designed in accordance with FIG. 2 and FIG. 3. The cryogenic system 100 further has a second refrigeration system 8 defined by a second circulation loop 82 which is only thermally coupled to the cold head 2 by the thermal interface 21. The cold head 2 provides liquefied helium serving as refrigerant R which is a first refrigerant R1 in the shown embodiment. The cold head 2 is configured to cool a second refrigerant R2 thereby liquefying the second refrigerant R2 which is cooled in the second circulation loop 82 to a second cryogenic temperature T2 (cf. FIG. 2 to FIG. 5). All lines are vacuum lines and enable the circulation of the second refrigerant R2 in the loop. The cold head 2 is received in a receiving space 7 having an associated protective device 3. The protective device 3 may be designed in accordance with FIG. 2 and FIG. 3 and has a gate valve 32 and a control valve 35 for selectively connecting the expandable vacuum space 31 to a pressure reservoir 34 (not shown).

The cryogenic system 100 has a plurality of valves 87. The plurality of valves 87 include a needle valve 87.1 and a shut-off valve 87.2 for selectively isolating the cold head 2 from the second circulation loop 82. The valves 87 may further comprise a pressure relief valve (not shown) for limiting the amount of pressure within the system 100, which may build up as a result of closing needle valve 87.1 and shut-off valve 87.2. The cryogenic system 100 may further have valve 87.3 for selectively blocking the flow path from the vacuum pump 83 to the 1K-pot 84.

The cryogenic system 100 further has a tank 88 and a tank control valve 87.4 configured for opening and/or closing a fluid connection between the tank 88 and the second circulation loop 82. The second circulation loop 82 is in fluid connection with the receiving space 7 and further has an evacuation valve 87.5 that is opened to store excess gas X from the receiving space 7 in the tank 88. By evacuating the excess gas X from the receiving space 7, loss of the excess gas X that corresponds to the refrigerant used in first and second circulation loop is avoided. It shall be understood that only excess gas X from the receiving space is evacuated while the first circulation loop for circulating the first refrigerant R1 is not affected.

FIG. 7 shows a second embodiment of the quantum computer system 200. The embodiment differs from the first embodiment shown in FIG. 6 in that the cold head of the first refrigeration system 1 is a first cold head 2.1 and the closed cycle cryogenic system 100, in particular the first circulation loop 10, comprises a plurality of cold heads, wherein only a second cold head 2.2 is shown and indicated with reference sign. The plurality of cold heads 2.1, 2.2 may be formed as shown in FIG. 1 to FIG. 5. The plurality of cold heads 2.1, 2.2 are in thermal connection with a second refrigeration system 8 via the thermal interface 21. The plurality of cold heads 2.1, 2.2 may either be received in the common receiving space (not shown) or each cold head 2.1, 2.2 may be associated with a respective receiving space 7.1, 7.2 independent from the receiving space of the other cold heads, as shown for example in FIG. 2. The receiving spaces 7.1, 7.2 associated to the cold heads 2.1, 2.2 has a protective device 3 (not shown, cf. FIG. 1 to 5) cooperating with the plurality of cold heads 2.1, 2.2 to allow release of one, more or all of said cold heads 2.1, 2.2. In the alternative, the plurality of receiving spaces each cooperates with the respective protective device 3 as described with regard to the embodiment shown in FIG. 1 to FIG. 5.

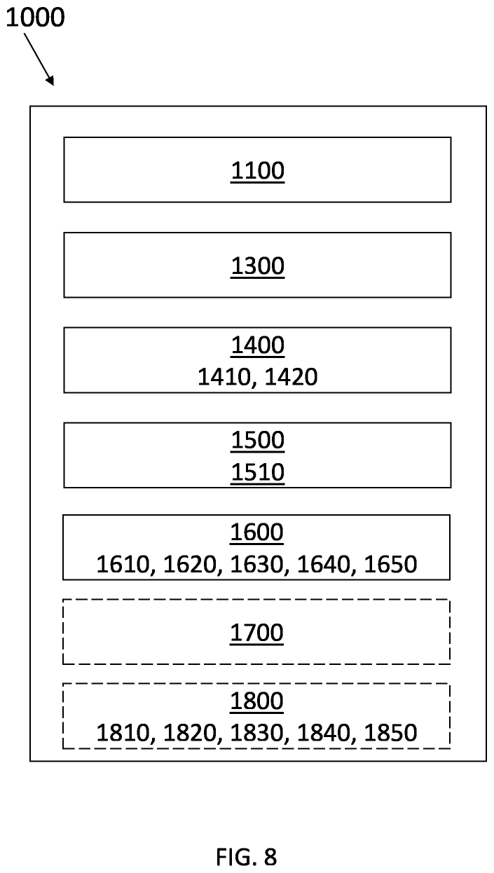

FIG. 8 shows a method 1000 for maintenance of the closed cycle cryogenic system 100 shown for example in FIG. 1 to FIG. 7. The method 1000 comprises in a first step 1100 evacuating excess gas X (cf. FIG. 6) from the receiving space 7, for example by selectively opening a tank control valve 87.4 and an evacuation valve 87.5 and pumping the excess gas X into at least one tank 88.

The method 1000 may comprise in a further step 1300 closing a tank control valve 87.4 after evacuation of excess gas X from the receiving space 7. Depending on the number of cold heads in the system, this step may further include closing the first shut-off valve 87.2 and/or the second shut-off valve 87.6. The method 1000 further comprises in step 1400 warming of the cold head 2 and in step 1500 releasing the cold head 2 from the receiving space 7. Step 1400 of warming the cold head 2 may comprise in a first part step 1410 turning off compressor 4 (cf. FIG. 1) and in alternative or in addition in a further part step 1420 turning on an electric heater 25 (cf. FIG. 2). The method 1000 further comprises in step 1600 preventing, during and after release of the cold head 2, the receiving space 7 from ingress of media differing from the refrigerant R by a protective device 3 associated to the receiving space 7.

The step 1500 may also include in part step 1510 releasing the cold head 2 through a passageway 33 of the protective device 3 and in case the protective devices 3 is formed in accordance with FIGS. 2 and 3, step 1600 further includes fluidically isolating the passageway 33 by a gate valve 32 in part step 1610.

In case the protective device 3 is formed in accordance with FIGS. 2 and 3, the method 1000 and in particular step 1600 further comprises a part step 1620 of opening a control valve 35 for selectively connecting a pressure reservoir 34 with the protective device 3, in particular the bellows 37 in a fluid conducting manner and in part step 1630 filling the bellows 37 with exchange gas E during or after release of the cold head 2 from the receiving space 7.

Moreover, in case the protective device 3 is formed in accordance with FIGS. 2 and 3, the method 1000 may comprise in a further part step 1640 closing the control valve 35 to stop supply of exchange gas E, followed in part step 1650 by breaking a vacuum seal 24 between the cold head 2 and the expandable vacuum space 31 and in part step 1660 removing the cold head 2 from the cryogenic system 100.

Thus, once it has been determined that the excess gas has been evacuated from the receiving space, the cold head 2 is now ready to be warmed up independent of the second circulation loop. Warming the cold head is achieved by turning off the compressor 4. Although the cold head 2 will normally warm up on its own having turned off the compressor 4, in some embodiments, one or more electrical heaters 25 may be coupled to the cold head 2 to speed up the warming process. Once the cold head 2 is reasonably warm, it is now safe to disengage the cold head 2 from the receiving space 7. In some embodiments, to disengage the cold head 2, it may be necessary to first fill the expandable vacuum space with exchange gas. Filling the expandable vacuum space with exchange gas causes the expandable vacuum space to extend in height thereby lifting the cold head 2 above the gate valve 32. The cold head 2 may then be manually lifted above the gate valve 32. Once the cold head 2 is lifted away from the system, the gate valve 33 is actuated by the actuation member 36 thereby closing the passageway 33. Closing the gate valve 32 helps to preserve the integrity of the vacuum in the receiving space 7 space vacated by the cold head 2.

The method 1000 may further comprise in step 1700 limiting the amount of pressure build up within the closed cycle cryogenic system 100, in particular within a second circulation loop 82 of the second refrigeration system 8, by opening a pressure relief valve (not shown). Step 1700 may be either executed after step 1600 of preventing the receiving space or before step 1600 of preventing the receiving space 7 from ingress of foreign media differing from the refrigerant R.

After executing said part steps, the cold head 2 may be serviced or completely replaced. In step 1800, the method 1000 comprises providing a new cold head 2 or a serviced cold head 2. Next, in a first part step 1810, the vacuum seal 24 is restored. After restoring the vacuum seal 24 in step 1810, the receiving space 7 and/or the expandable vacuum space 31 (cf. FIG. 2 and FIG. 3) are evacuated in part step 1820. Next, the gate valve 32 may be opened in part step 1830 before the cold head 2 is moved through the passageway 33 in step 1840. After moving the cold head 2 through the passageway 33, the method 1000 comprises in part step 1850 precooling the cold head 2 by starting the compressor 4 and in part step 1860 connecting the cold head 2 to the second refrigeration system 8.

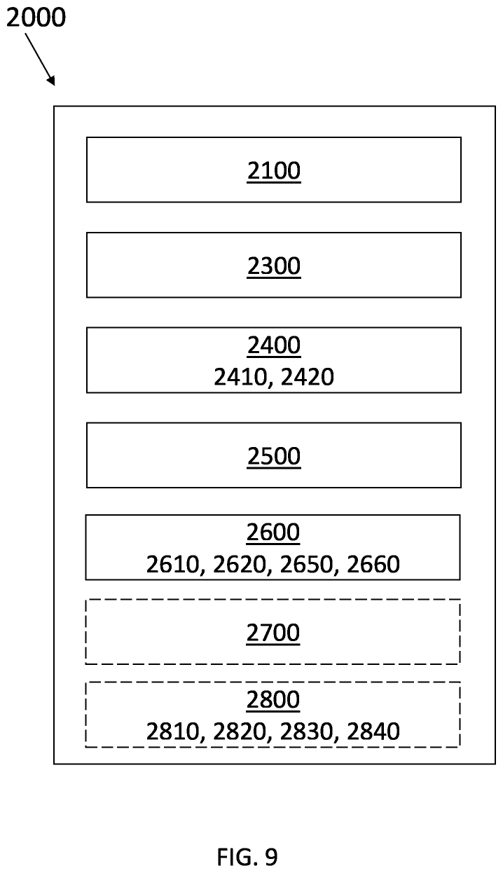

FIG. 9 shows a second embodiment of the method 2000. The method 2000 comprises evacuating excess gas X (cf. FIG. 6) from a receiving space associated with a cold head 2, preferably by selectively opening a tank control valve 87.4 and pumping the excess gas X into at least one tank 88 in a first step 2100.

The method 2000 comprises in a further step 2300 closing a tank control valve 87.4 after evacuation of excess gas. The method 2000 further comprises in step 2400 warming of the cold head 2 and in step 2500 releasing the cold head 2 from the receiving space 7. Finally, the method 2000 comprises in step 2600 preventing the receiving space 7 from ingress of media differing from the refrigerant R by a protective device 3 associated to the receiving space 7 during and after release of the cold head 2.

Preferably, warming the cold head 2 in step 2400 includes in a first part step 2410 turning off a compressor 4 (cf. FIG. 2) and in alternative or in addition in a further part step 2420 turning on an electric heater 25 (cf. FIG. 2).

Preferably, the method 2000 further comprises in step 2700 limiting the amount of pressure within the closed cycle cryogenic system 100, in particular within a second circulation loop 82 by opening a pressure relief valve (not shown). Step 2700 may be either executed after preventing the receiving space from ingress of foreign media differing from the refrigerant R in step 2600 or before the latter.

Preventing the receiving space from ingress of media differing from the refrigerant R in step 2600 may further comprise in a first part step 2620 opening a control valve 35 to selectively connect the pressure reservoir 34 with the gas curtain 38 in a fluid conducting manner and in another part step 2620 filling the receiving space 7 by maintaining a supply of exchange gas E from the pressure reservoir 34, wherein the exchange gas E corresponds to the refrigerant R. After release of the cold head and protecting the receiving space 7 by filling the receiving space 7 with exchange gas E in part step 2620, the method 2000 further comprises in part step 2650 breaking a vacuum seal 23 on the cold head 2 to the receiving space 7 and in step 2660 removing the cold head 2.

The method 2000 further comprises providing a new or serviced cold head 2 in step 2800 including restoring a vacuum seal 24 (cf. FIG. 2 and FIG. 3) to the receiving space 7 on a new cold head 2 in part step 2810 and closing the control valve 35 to stop supply of exchange gas in part step 2820, before connecting the cold head 2 to the second refrigeration system 8 in part step 2830 and executed before or afterwards in part step 2840, precooling the cold head 2 by starting the compressor 4.

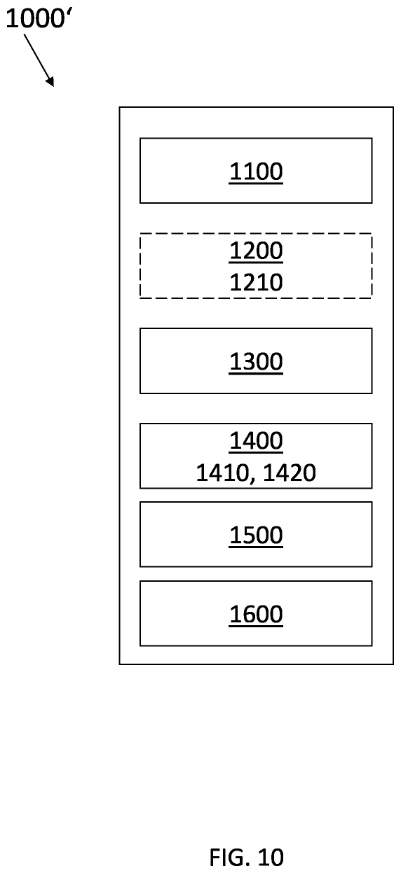

FIG. 10 shows another embodiment of the method 1000′ having steps 1100 to 1600 described with regard to FIG. 9. Reference is made to the above description of the method.

Method 1000′ shown in FIG. 10 differs from method 1000 shown in FIG. 8 by thermally and preferably fluidically isolating the cold head 2 and/or receiving space 7 from the second refrigeration system 8, in particular from the second refrigeration loop 82 in step 1200.

Further, warming the cold head 2 in step 1400 is executed before releasing the cold head 2 from the receiving space in step 1500 in method 1000′.

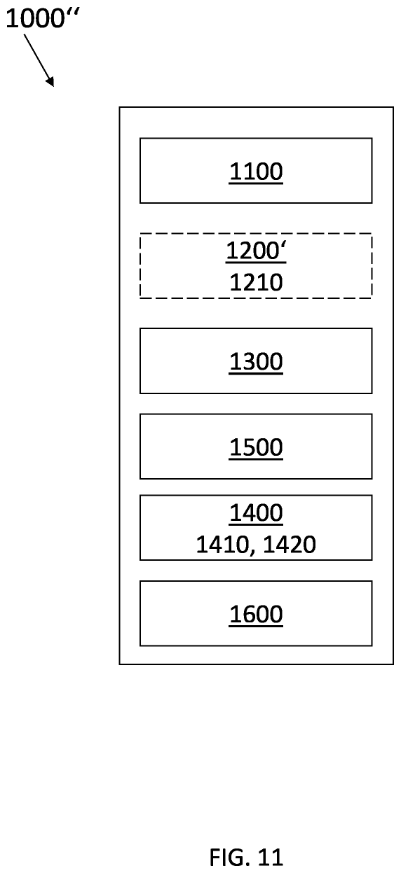

FIG. 11 shows another embodiment of the method 1000″ having steps 1100 to 1600 described with regard to FIG. 8. Reference is made to the above description of the method.

Method 1000″ shown in FIG. 11 differs from the method 1000′ shown in FIG. 10 by step 1200′ in which the cold head 2 is fluidically isolated from the second refrigeration system 8, wherein a thermal isolation is not necessary according to this embodiment.

In method 1000″, warming the cold head 2 in step 1400 is executed after release of the fluidically isolated cold head 2 from the receiving space 7 in step 1500. Since the cold head is first released from the receiving space 7 in step 1500, a thermal isolation of the cold head 2 from the second refrigeration system 8 is not necessary.

### Reference Signs

1 first refrigeration system
2 cold head
2.1 first cold head
2.2 second cold head
3 protective device
4 compressor
5 vacuum shroud
6 radiation shield
6.1 first radiation shield
6.2 second radiation shield
7 receiving space
7.1 first receiving space
7.2 second receiving space
8 second refrigeration system
9 first cooling station, first cold plate
10 first circulation loop
11 second cooling station
20 thermal interface
21 first stage
22 second stage
23 second room temperature flange
24 vacuum seal
25 electrical heater
31 expandable vacuum space
32 gate valve
33 passageway
34 tank
35 control valve
37 bellows
38 gas curtain
39 annular header
39A number of apertures
41 supply line
42 return line
51 first room temperature flange
82 second circulation loop
83 vacuum pump
84 1 K pot
86 expansion valve
87 number of valves
87.1 needle valve
87.2 (first) shut-off valve
87.3 pneumatic valve
87.4 tank control valve
87.5 evacuation valve
87.6 second shut-off valve
88 tank
89 substrate interface
200 quantum computer system
210 quantum processor
220 qubit
230 low temperature environment
R refrigerant
E exchange gas
X excess gas
T1 first cryogenic temperature
T2 second cryogenic temperature
X1 first distance
X2 second distance

1. A closed cycle cryogenic system (100) comprising:
a first refrigeration system (1) having at least one cold head (2) and a compressor (4) coupled to the cold head (2) for carrying a compressed refrigerant (R) to the cold head (2) and for returning low pressure refrigerant (R) originating from the cold head (2),
a vacuum shroud (5) at least partly enclosing the cold head (2) and being configured to minimize convective heat transfer to the cold head (2),
a radiation shield (6) enclosed by the vacuum shroud (5) and being configured to insulate at least a part of the cold head from thermal radiation emitted from the vacuum shroud (5),
a receiving space (7) at least partly extending through the radiation shield (6) and the vacuum shroud (5), wherein the receiving space (7) is configured to receive the cold head (2),
a second refrigeration system (8) at least partly enclosed by the radiation shield (6) and thermally coupled to the first refrigeration system (1), and
at least one protective device (3) associated to the receiving space (7), wherein the at least one protective device (3) is configured to allow release of the at least one cold head (2) from the receiving space (7) by protecting the receiving space (7) from ingress of media differing from the refrigerant (R).

2. (canceled)

3. The closed cycle cryogenic system (100) according to claim 1, further comprising:
a first room temperature flange (51) associated to the receiving space (7), and
a second room temperature flange (23) associated to the cold head (2),
wherein the protective device (3) is arranged between the first room temperature flange (51) and the second room temperature flange (23).

4. The closed cycle cryogenic system (100) according to claim 1,
wherein the protective device (3) comprises a gate valve (32) having a sealable passageway (33) and an expandable vacuum space (31) configured to allow movement of the cold head (2) relative to receiving space (7) through the passageway (33) for release of the cold head (2).

5. The closed cycle cryogenic system (100) according to claim 4,
wherein the expandable vacuum space (31) is attached to both the receiving space (7) and the cold head (2).

6. The closed cycle cryogenic system (100) according to claim 4,
wherein the expandable vacuum space (31) is defined by a bellows (37) attached to the cold head (2) which is configured to receive an exchange gas (E) at least during or after release of the cold head (2) from the receiving space (7).

7. (canceled)

8. The closed cycle cryogenic system (100) according to claim 4,
wherein the gate valve (32) is associated to the receiving space (7) and configured to preserve the integrity of a vacuum in the receiving space (7).

9. The closed cycle cryogenic system (100) according to claim 1,
wherein the protective device (3) comprises a gas curtain (38) configured to selectively fill the receiving space (7) by maintaining a supply of an exchange gas corresponding to the refrigerant (R) to prevent the receiving space (7) from ingress of media differing from the refrigerant (R).

10. (canceled)

11. The closed cycle cryogenic system (100) according to claim 1, wherein the cold head (2) includes a first stage (21) for executing a first cooling cycle for precooling the refrigerant (R), a second stage (22) for executing a second cooling cycle for cooling the precooled refrigerant (R) to a cryogenic temperature, wherein the radiation shield (6) insulates the second stage (22), and the closed cryogenic system (100) further comprising a thermal interface (20) configured for coupling the first refrigeration system to the second refrigeration system (8).

12.-13. (canceled)

14. The closed cycle cryogenic system (100) according to claim 11, further comprising:
a first cooling station (9) and a second cooling station (11) associated to the cold head (2),
wherein the second stage (22) of the cold head (2) is arranged at a first distance (X1) from the first cooling station (9) and at a second distance (X2) from the second cooling station (11), wherein the second cooling station (11) is cooler than the first cooling station (9) and the second distance (X2) is smaller than the first distance (X1).

15. The closed cycle cryogenic system (100) according to claim 14, wherein the second distance (X2) is 1/15 or less of the first distance (X1).

16. The closed cycle cryogenic system (100) according to claim 1, further comprising at least one electrical heater (25) coupled to the cold head (2), the at least one heater (25) being configured for one or more of the following:
heating the cold head (2) within the receiving space (7);
heating the cold head (2) after release from the receiving space (7), wherein the at least one electric heater is coupled to the cold head (2) and configured to be moved with the cold head (2); and
heating the cold head (2) after release from the receiving space (7), wherein the electric heater (25) is coupled to the cold head (2).

17. The closed cycle cryogenic system (100) according to claim 1,
wherein the cold head (2) is a first cold head (2.1) and the closed cycle cryogenic system (100) comprises a plurality of cold heads (2.1, 2.2) including the first cold head (2.1),
wherein each cold head (2, 2.1, 2.2) of the plurality of cold heads (2, 2.1, 2.2) is in thermal connection with the second refrigeration system (8),
wherein each cold head (2, 2.1, 2.2) of the plurality of cold heads (2, 2.1, 2.2) is releasably mounted in a corresponding receiving space (7, 7.1, 7.2) of a plurality of receiving spaces (7, 7.1, 7.2),
wherein the at least one protective device (3) is coupled to one, more or all of the plurality of receiving spaces (7, 7.1, 7.2) and configured to allow release of one, more or all of the plurality of cold heads (2, 2.1, 2.2) from the respective receiving space (7, 7.1, 7.2).

18. The closed cycle cryogenic system (100) according to claim 17, wherein each one of the plurality of receiving spaces (7, 7.1, 7.2) is coupled to an associated protective device (3).

19. to 23. (canceled)

24. A quantum computer system (200) comprising a quantum processor (210) operating at cryogenic temperatures and a closed cycle cryogenic system (100) according to claim 1 for the quantum processor (210).

25. A method (1000, 1000′, 1000″, 2000) for maintenance of a closed cycle cryogenic system (100), wherein the closed cycle cryogenic system (100) comprises a first refrigeration system (1) with a cold head (2) for providing a refrigerant (R) at a first cryogenic temperature, a compressor (4) coupled to the cold head (2), and a thermal interface at least partly enclosed by the radiation shield (6) and being configured for thermally coupling the first refrigeration system (8) to the second refrigeration system (1), the method (1000, 1000′, 1000″, 2000) comprising the steps:
evacuating excess gas from the receiving space (7) and pumping the excess gas into at least one tank (88),
warming (1400) the cold head (2),
releasing (1500) the cold head (2) from a receiving space (7), and
preventing (1600) the receiving space (7) from ingress of media differing from the refrigerant (R) using a protective device (3) associated to the receiving space (7) in case the cold head (2) is released, in particular during and after release of the cold head (2).

26. (canceled)

27. The method (1000′) according to claim 25, further comprising at least one of the steps:
thermally isolating (1200) the cold head (2) from the second refrigeration system (8), and
fluidically isolating (1200) the receiving space (7) from the second refrigeration system (8),
wherein the step of warming (1400) the cold head (2) is executed before or after releasing (1500) the cold head (2) from the receiving space (7).

28.-29. (canceled)

30. The method (1000) according to claim 25,
wherein releasing (1500) the cold head (2) includes moving (1510) the cold head (2) through a passageway (33) of the protective device (3) and wherein preventing (1600) the receiving space (7) from ingress of media differing from the refrigerant (R) includes fluidically isolating (1610) the passageway (33) by a gate valve (32) of the protective device (3).

31. The method (1000) according to claim 30,
wherein the protective device (3) comprises an expandable vacuum space defined by a bellows attached to the cold head (2), the method further comprising the step:
opening (1620) a control valve (35) to selectively connect a pressure reservoir (34) with the bellows (37) in a fluid conduction manner, and
filling (1630) the bellows (37) with exchange gas (E) during or after release of the cold head (2) from the receiving space (7).

32. (canceled)

33. The method (2000) according to claim 25,
wherein the protective device (3) comprises a gas curtain (38), the method (2000) further comprising the step:
opening (2610) a control valve (35) to selectively connect a pressure reservoir (34) with the gas curtain (38) in a fluid conduction manner, and
filling (2620) the receiving space (7) by maintaining a supply of an exchange gas (E) from the pressure reservoir (34) corresponding to the refrigerant (R).

34. (canceled)

35. The closed cycle cryogenic system according to claim 1, wherein the at least one protective device is configured to allow release of the at least one cold head (2) from the receiving space (7) and the protective device.
